(19) United States
(12) Patent Application Publication
(10) Pub. No.: US 2020/0290448 A1
(43) Pub. Date: Sep. 17, 2020

(54) Angular momentum engine

(71) Applicant: Michael Joseph Carew, Franklin, NJ (US)

(72) Inventor: Michael Joseph Carew, Franklin, NJ (US)

(21) Appl. No.: 16/501,267

(22) Filed: Mar. 14, 2019

(51) Int. Cl. B60K 6/48; F16H 61/664

(52) U.S. Cl. CPC B60K 6/48; B60K 6/40; F16H 61/6648

(57) ABSTRACT

The alternative energy system in this patent application use three simple systems: angular momentum, centrifugal force, and relative motion to create one of the most powerful alternative engines in the world. The design of this engine can be used across the broad spectrum of transportation including space.

“Centrifugal force can be increased by increasing either the speed of rotation or the mass of the body or by decreasing the radius, which is the distance of the body from the center of the curve. Increasing the mass or decreasing the radius increases the centrifugal force in direct or inverse proportion, respectively, but increasing the speed of rotation increases it in proportion to the square of the speed; that is, an increase in speed of 10 times say from 10 to 100 revolutions per minute, increase the centrifugal force by a factor of one hundred”. * Written by the editors of Encyclopedia Britannica last updated Feb. 13, 2018.

The problem is that angular momentum produces a rotating, not a ‘linear force’. One of the problems confronted in the patent application was the changing of a rotating centrifugal to a ‘linear centrifugal force’ through the science of relativity to harness one of the most powerful alternative types of energy ‘angular momentum’.

It is seen in atoms, where electrons move above the speed of light, in calculus where Sir Isaac Newton calculated the forces of gravity on the planets, in Tesla engines, in Nascar flywheels, UPS systems, and in every wheel that spins from the old stage coaches spoked wheels to the stealth bomber engines of today.

This centrifugal force is quadrupled as its velocity doubles, as proven by its formula and endless scientific documentation, making it one of the best choices for an alternative energy source in a world of depleting fossil fuels.

This patent application illustrates an ‘angular momentum engine’ that produces well over 6.208 foot pounds of centrifugal force for use in the automotive industry. As the centrifugal force created by angular momentum is only limited by its velocity and mass, these accelerating forces can easily reach a half million foot pounds of centripetal force in larger engines for space flight.

### BACKGROUND

With only a 40 year supply of fossil fuels remaining worldwide, new cleaner sources of alternative energy such as automotive ‘hybrid systems’ are on the forefront in development. Some automakers such at Mercedes Benz will no longer make cars with internal combustion engines as they look to their future in electric vehicles, while others such as Tesla Motors use the AC 3 phase induction motor, invented by the genius Nichols Tesla, in their electric cars.

The alternative energy system in this patent application uses three simple systems: angular momentum, centrifugal force, and relative motion to create one of the more powerful alternative engines in the world. The design of this engine can be used across the broad spectrum of transportation including space.

The system design in this patent application uses as its base the angular momentum of a ‘point mass’ turning on an axis like a ball on the end of a string.

The angular momentum of a ‘point mass’ rotating on an axis produces a ‘centripetal force’. This centripetal force is an inward force that keeps a mass in a circular path. The centrifugal force, the opposite reaction to the centripetal force, pulls outward on the rotating mass. FIG. 6A

As the centrifugal force created by angular momentum is only limited by its velocity and mass, this accelerating force can easily reach a ‘half million pounds’ in a larger engine for use in space flight, but for purposes of this patent application the design is limited for use in the automotive industry.

“Centrifugal force can be increased by increasing either the speed of rotation or the mass of the body or by decreasing the radius, which is the distance of the body from the center of the curve. Increasing the mass or decreasing the radius increases the centrifugal force in direct or inverse proportion, respectively, but increasing the speed of rotation increases it in proportion to the square of the speed; that is, an increase in speed of 10 times say from 10 to 100 revolutions per minute, increase the centrifugal force by a factor of one hundred”. ** ** Written by the editors of the Encyclopedia Britannica last updated Feb. 13, 2018.

It is this centrifugal force, the outward reaction force, that is used to accelerate an automobile as outlined in the following pages of this patent application.

### 2017 BRIEF DESCRIPTION OF THE DRAWINGS

FIG. 1—System design—1 stage planetary gearbox

FIG. 1a.—System design—1 stage planetary gearbox (top view)

FIG. 1b.—System design—1 stage planetary gearbox (bottom view)

FIG. 2.—System design—Angular Momentum Engine (front view)

FIG. 3a—101 Planetary gearbox 1—top view (clockwise rotation)

FIG. 3b—101 Planetary gearbox 1—top view (clockwise rotation)

FIG. 3c—102 Planetary gearbox 2—top view (counter-clockwise rotation)

FIG. 3d—102 Planetary gearbox 2—top view (counter-clockwise rotation)

FIG. 4-1—Pinion Gear—2.5×2 inch spur gear (42 teeth)

FIG. 4-2—Planet Gear—5.0×2 inch spur gear (84 teeth)

FIG. 4-3—Sun Gear—5.0×2 inch spur gear (84 teeth)

FIG. 6A—Equation for Centrifugal force

FIG. 6B—Centripetal forces—proportional to the square of the velocity

FIG. 8—Patent Design compared other planetary gearboxes

FIG. 9a—Planetary gearbox 1—top view (clockwise rotation)

FIG. 9b—Planetary gearbox 2—top view (counter-clockwise rotation)

FIG. 10-1—Point mass (6a. 6b, 6c, 6d)—Centrifugal force from planet axis

FIG. 10-2—Point mass (6a)—Centrifugal force from sun gear

FIG. 10-3—point mass (6c)—Centrifugal force from sun gear

### BRIEF DESCRIPTION OF THE INVENTION

This patent application illustrates how to change a rotating centrifugal force, from the perspective of an ‘at-rest’ observer, to a linear centrifugal force, by using the science of relativity to harness one of the most powerful and highly energy efficient source of alternative energy . . . angular momentum.

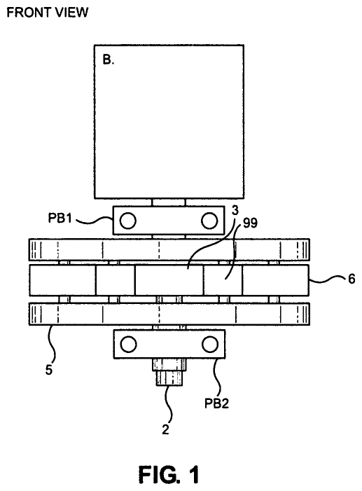

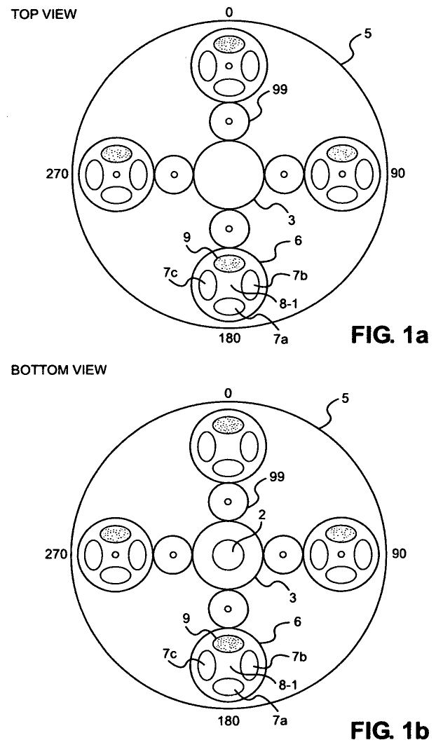

FIG. 1 This ‘Angular Momentum engine’ uses a simple 1 stage planetary gearbox in its design. The 3. ‘sun gear’ has 84 teeth, the 99. ‘pinion’ 42 teeth, the 6. ‘planet gear’ 84 teeth. The 3. ‘sun gear’ is held by the 2. ‘sun gear shaft’. The gearbox does not have an internal ring gear.

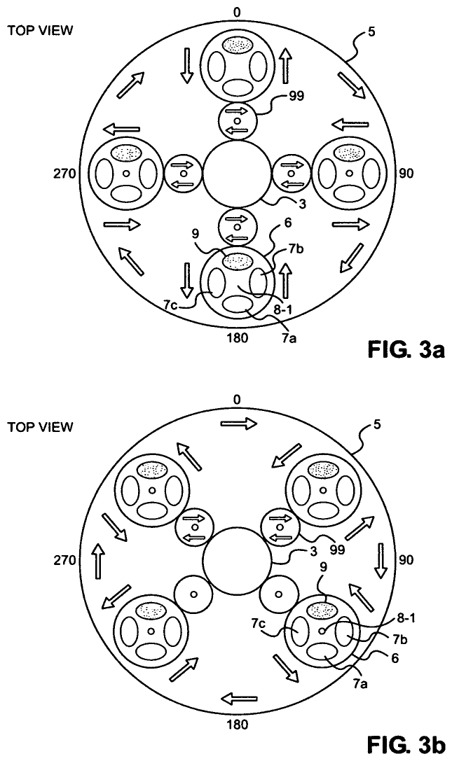

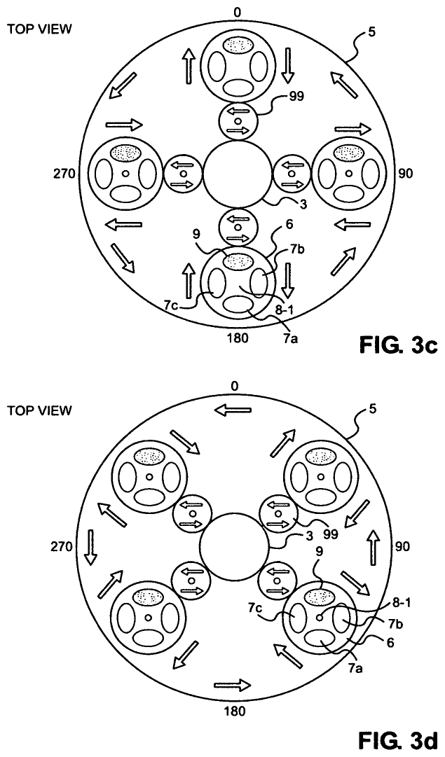

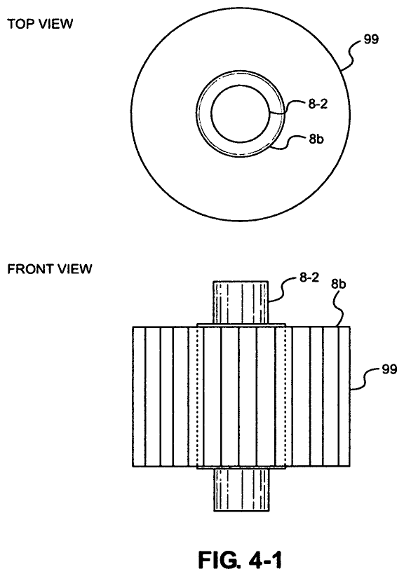

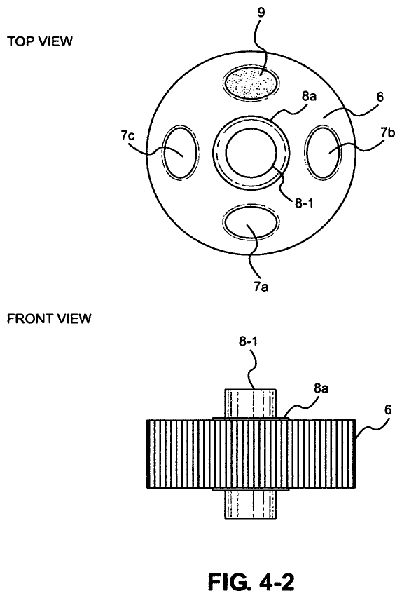

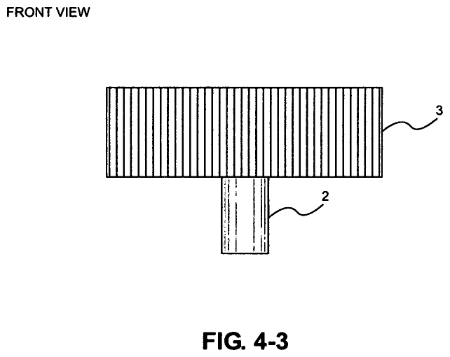

FIG. 1a FIG. 1b. This 1 stage planetary gearbox has a 5. ‘carrier’, four 6. ‘planet gear's, four 99. ‘pinion gear's, a one piece 3. ‘sun gear’, and 2. ‘sun gear shaft’ design FIG. 4-3

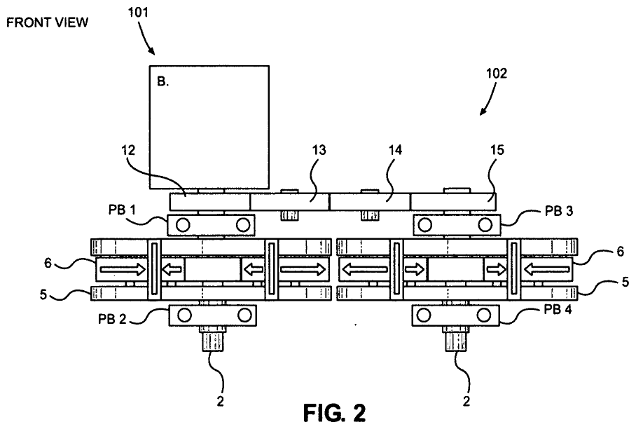

FIG. 4-2 illustrates the Planet Gear′. Three lightening holes are machined into the planet gears called an ‘empty shell’. It's purpose is twofold. The 7b. ‘empty shell’ and 7c. ‘empty shell’ reduce the mass of the 6. ‘planet gear’ to improve ‘spin up time’. The 7a. ‘empty shell’ creates a point on the 6. ‘planet gear’ that has no mass and a point on the 6. ‘planet gear’ that has more mass, the 9. ‘point-mass’.

FIG. 4-2 The 9. ‘point-mass’ is 0.3 kg. (0.66 lbs) less than a pound. The mass removed from the 7a. ‘empty shell’, 7b. ‘empty shell’, and 7c. ‘empty shell’ is 0.3 kg. (0.66 lbs) for each of the three ‘empty shell's.

FIG. 4-1 illustrates the Pinion Gear

FIG. 4-3 illustrates the Sun Gear

FIG. 1 FIG. 3a FIG. 3b The AC B. ‘3 phase induction Motor’ rotates the 5. ‘carrier’ assembly 6. ‘planet gear's and 99. ‘pinion gear's around the ‘held’ 3. ‘sun gear’. As the 6. ‘planet gears are rotated around the ‘held’ 3. ‘sun gear’, a centrifugal force is created on each 9. ‘point-mass’ as a result of their angular momentum.

FIG. 1 FIG. 3a FIG. 3b The 6. ‘planet gear's are simultaneously turned in the opposite direction on their axis as a result of the ‘held’ 3. ‘sun gear’ creating a second centrifugal force on each 9. ‘point-mass’ as a result of their angular momentum.

These two sets of ‘centrifugal forces’ are examined in the following detailed description.

### DETAILED DESCRIPTION

There is a huge diversity in the design of planetary gearboxes compared to this ‘patent design’ In a standard automotive transmission one gear is held, one turned, and one gear used as the output to drive the vehicle. This design enables the vehicle torque to match the vehicle load while the automobile is accelerating to highway speed.

The ‘fly by wire’ hybrid Toyota Prius ‘power split device’ is designed to use input from its two permanent magnet motor/generators, MG2 and MG1 as well as its internal combustion engine (ICE) to specifically match torque with load demands in this 60 mile per gallon hybrid system.

The complex Allison transmission uses sets of gears, called a compound planetary gearset, that looks like a single planetary gearset but actually works like two planetary gearsets combined. It has one ring gear that is always the output of the transmission, but it has two sun gears and two sets of planets.

Each of these transmissions have in common an output drive shaft that is used to turn the vehicle's wheels.

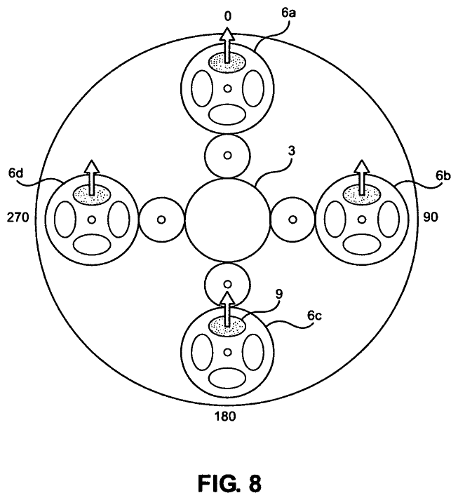

In this patent design gearbox the relative motion of a point-mass generates a linear centripetal force (see arrows) FIG. 8 that accelerate the vehicle, thereby eliminating the necessity for an output drive shaft.

This Angular Momentum Engine uses two identical ‘side by side’ 1 stage’ planetary gearboxes. FIG. 2

The two identical side by side gearboxes 101. ‘Planetary Gearbox 1’ and 102. ‘Planetary Gearbox 2’ run in opposite directions to balance the rotational forces. FIG. 2

FIG. 2 FIG. 3a FIG. 3b The AC B. ‘3 phase induction Motor’ running at +¼ rpm turns the 12. ‘gear 1’ and the 5. ‘carrier’ assembly +¼ rpm clockwise. With the 3. ‘sun gear’ held and the 5. ‘carrier’ assembly 6, ‘planet gear's and 99. ‘pinion gear's rotated at +¼ rpm clockwise around the 3. ‘sun gear’ the 6. ‘planet gear's are simultaneously turned −¼ rpm counter-clockwise on their axes in 101. ‘planetary gearbox 1’.

The 102. ‘planetary gearbox 2’ gears turn in the opposite direction of 101. ‘planetary gearbox 1 due to 12. ‘gear 1’, the drive gear, 13. ‘gear 2’ and, 14. ‘gear 3’ the idler gears and 15. ‘gear 4’ the driven gear reversing the rotation direction of the input to 102. ‘Planetary Gearbox 2. They have a 1:1 gear ratio. FIG. 2

FIG. 2 FIG. 3c FIG. 3d With the reversing driven 15. ‘gear 4’ running at −¼ rpm it turns the 5. ‘carrier’ assembly −¼ rpm counter-clockwise. With the 3. ‘sun gear’ held the 5. ‘carrier’ assembly 6, ‘planet gear's and 99. ‘pinion gear's are rotated −¼ rpm counter-clockwise around the 3. ‘sun gear’ while simultaneously the 6. ‘planet gear's turn +¼ rpm clockwise on their axes in the 102. ‘planetary gearbox 2’.

This very slow motion analogy is used to illustrate the movement of the component parts of this Angular Momentum Engine.

The linear centripetal force of this ‘angular momentum engine’ is 3,096 ft/lbs. at 4000 rpm for each of the two ‘side by side” planetary gearboxes, 101. ‘planetary gearbox 1’ and 102. ‘planetary gearbox 2’, for a total of 6,192 ft/lbs, of centrifugal force for this ‘angular momentum engine’. FIG. 2

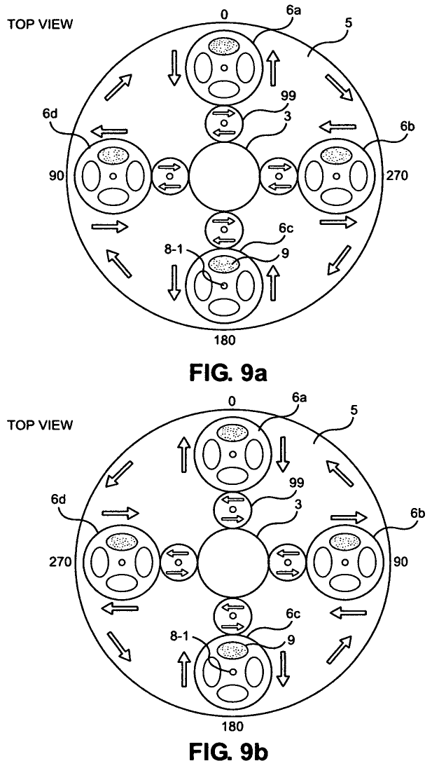

The 3.096 ft/lbs. of centrifugal forces, for 101. planetary gearbox 1 is the sum of the clockwise rotation of the ‘planet gear’ (6a, 6b, 6c, 6d). by the 5. ‘carrier’, and the counter-clockwise turning of the ‘planet gear’ (6a, 6b, 6c, 6d). as a result of the 3. ‘sun gear’. being held. FIG. 9a

The 3,096 ft/lbs. of centrifugal forces, for 102. ‘planetary gearbox 2’ is the sum of the counter-clockwise rotation of the ‘planet gear’ (6a, 6b, 6c, 6d). by the 5. ‘carrier’, and the clockwise turning of the ‘planet gear’ (6a, 6b, 6c, 6d). as a result of the 3. ‘sun gear’ being held. FIG. 9b

In summary, the 2^{nd} planetary gearbox runs in the opposite direction of the 1^{st} planetary gearbox each producing 3,096 ft/lbs of linear centripetal force at 4000 rpm.

An explanation of how this 3,096 ft/lbs of linear centripetal force is created for each of the two planetary gearbox at 4000 rpm follows.

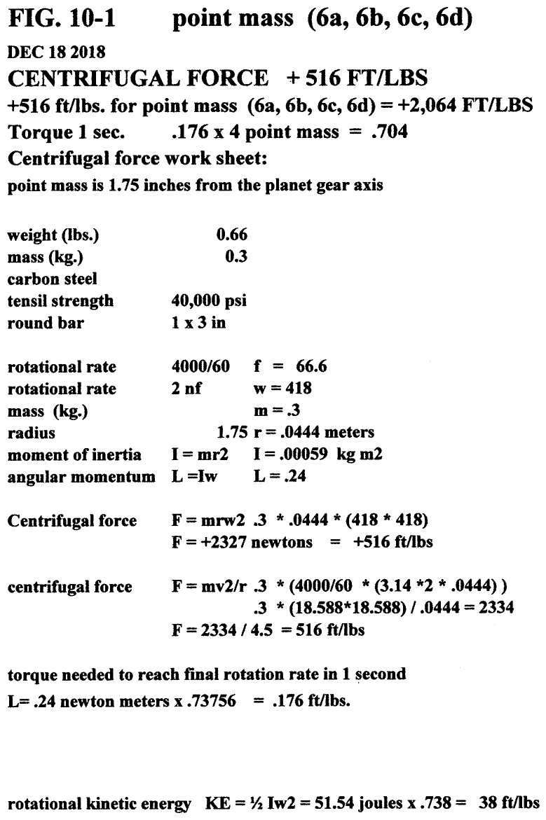

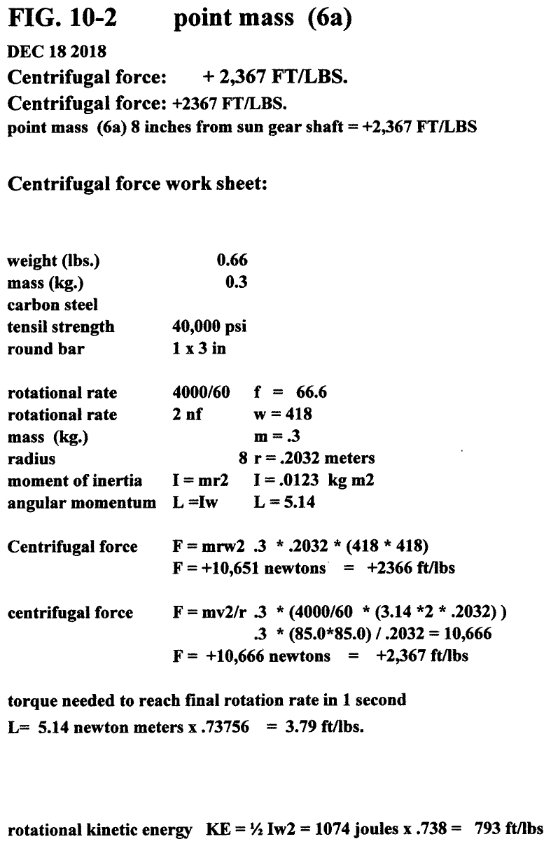

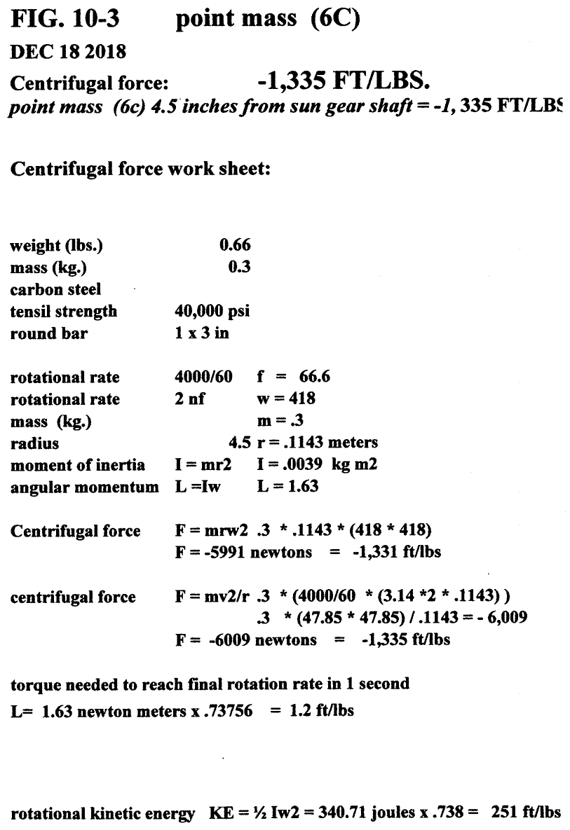

The 0.66 lb. ‘point-mass’ (0.3 kg) on ‘planet gears’ 1 thru 4 (6a, 6b, 6c, 6d) in 101. ‘planetary gearbox 1’ and 102. ‘planetary gearbox 2’ are 1.75 inches away from the 8-1. ‘planet gear axis’, each creating +516 foot-pounds of centripetal force as they are turned 4000 rpm. FIG. 10-1 FIG. 9a FIG. 9b

The 0.66 lb. ‘point-mass’ (0.3 kg) on 6a. ‘planet—1’ in 101. ‘planetary gearbox 1’ and 102. ‘planetary gearbox 2’ are 8.0 inches away from the 3. ‘sun gear’, creating +2,367 foot-pounds of centripetal force. as it is rotated 4000 rpm.

FIG. 10-2 FIG. 9a FIG. 9b

The 0.66 lb. ‘point-mass’ (0.3 kg) on 6c. ‘planet—3’ in 101. ‘planetary gearbox 1’ and 102. ‘planetary gearbox 2’ are 4.5 inches away from the 3. ‘sun gear’, creating a negative −1,335 foot-pounds of centripetal force as it is rotated 4000 rpm. FIG. 10-3 FIG. 9a FIG. 9b

In summary, the sum of these forces [516+516+516+516+2,367−1,335] equals +3,096 foot pounds of linear centrifugal force at 4000 rpm for 101. ‘planetary gearbox 1’. and 102. ‘planetary gearbox 2, for a total of 6,192 ft/lbs. of linear centrifugal force.

The linear centrifugal force for each of the planet gears (6a, 6b, 6c, 6d) ‘point mass’ change as they rotate around the 3. ‘sun gear’. The net sum of these forces, however, remains the same at 3,096 foot pounds for 101. ‘planetary gearbox 1’. and 3,096 foot pounds for 102. ‘planetary gearbox 2 as the planet gears rotate around the 3. ‘sun gear’. FIG. 9a FIG. 9b

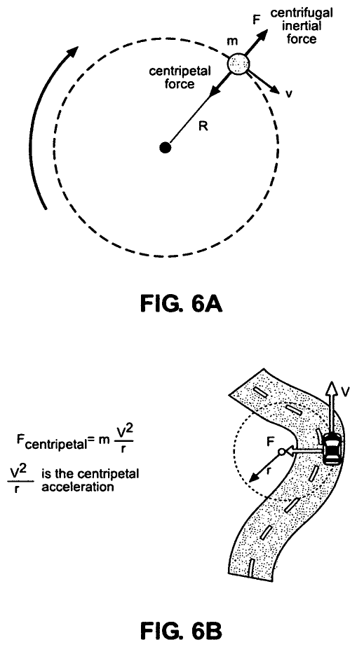

This ‘patent gearbox’ is 95 percent efficient, the speed of rotation increases its centrifugal force in proportion to the square of the speed, making it one of the most efficient and powerful engines in today's marketplace. FIG. 6B

The Tesla electric motor delivers 360 to 470 HP depending on the model. Using this electric motor as input, the ‘linear centrifugal force’ for each of the two gearboxes with a (0.66 lbs.) point-mass are:

| | | |
|---|---|---|
| Planetary gearbox 1 | Planetary gearbox 2 | Total |

| | | | | | |
|---|---|---|---|---|---|
| 193.5 | ft/lbs. @ 1000 rpm | 193.5 | ft/lbs. @ 1000 rpm | 387 | ft lbs. |
| 774 | ft/lbs. @ 2000 rpm | 774 | ft/lbs. @ 2000 rpm | 1,548 | ft lbs. |
| 3,096 | ft/lbs. @ 4000 rpm | 3,096 | ft/lbs. @ 4000 rpm | 6,192 | ft lbs. |
| 12,384 | ft/lbs. @ 8000 rpm | 12,384 | ft/lbs. @ 8000 rpm | 24,768 | ft/lbs. |
| 49,536 | ft/lbs. @16000 rpm | 49,536 | ft/lbs. @16000 rpm | 99,072 | ft lbs. |

The 687 lb/ft flat line torque curve of the Tesla induction motor is applied during acceleration. The maximum torque of an induction motor is at zero rpm. This means that right from the moment the motor starts to rotate a near maximum torque is available. Induction motors are also used in the e-hybrid Formula One race cars putting a spotlight on the power/torque capabilities of these hybrid technologies.

Increasing the speed of rotation increases the linear centripetal force in proportion to the square or the speed, from 1,000 to 16,000 or 16 squared. The linear centrifugal force is 256 times greater for this ‘angular momentum engine’ at 16,000 rpm (99,072 ft/lbs) than at 1000 rpm (387 ft/lbs). Increasing the point-mass, by four, from 0.66 to 2.64 pounds produces 400,000 ft/lbs of centripetal force @ 16,000 rpm.

Although these forces are well beyond the normal automotive power/torque curve it brings into sharp focus the sheer power of this type of engine for use across the broad spectrum of transportation including space.

This Angular Momentum Engine has a 280 mpg highway estimate for a 3,200 pound automobile. and is 95 percent efficient, as its linear centrifugal force quadruples as its rotational velocity doubles. FIG. 2

In comparison a hybrid automobile with LI-ion batteries has a 99 percent charge efficiency and the discharge loss is small, with a 63 mpg estimate. The energy efficiency of a fuel cell is 20 to 60 percent and the internal combustion engine is 25 to 30 percent, giving significantly lower mpg ratings.

It is not the purpose of this patent application to define the type of Motor that would be used as input, nor to define and illustrate the type of hybrid system to incorporate with this patent ‘Angular Momentum Engine’. It is, however, its purpose to highlight the maximum capability of its design for marketability and utilization.

“Most of the auto manufacturers use synchronous motors, but whether it is a permanent magnet or electromagnet strongly influences the performance. Tesla Motors in its new Model-3 uses a permanent magnet electric motor instead of the AC induction motor it has used so far. The key difference is that AC induction motors have to use electricity to generate the magnetic currents inside the motor, which cause the rotor to spin, whereas a permanent magnet motor doesn't require that additional current since its magnets are always ‘on’. This means that the Model-3's motor is more efficient and thus better for smaller and lighter cars, but not ideal for high performance cars, since an AC induction motor can produce greater power.”

The 3 phase A/C induction motor invented by the genius Nicholas Tesla has a simple and rugged construction. This Tesla motor has no permanent magnets, no brushes, no communicator ring, and no position sensors. A variable speed drive controls the 3 phase current input power frequency. It uses highly permeable thin slices of steel laminations inside a steel or cast iron frame minimizing eddy currents. The Tesla roadster electric motors offer 758 lb/ft of torque nearly 1000 hp.

In a hybrid setting, the A/C Tesla asynchronous induction motors can also be used to generate electricity. When used as a motor the rotating magnetic field is greater than the rotor, when used as a generator the rotating magnetic field is less that the rotor. The Toyota Prius hybrid ‘power split device’ PM synchronous motor MG2 and MG1, spin at the same speed at its rotating magnet field.

When these A/C Tesla induction motor/generators are used on its automobiles wheels to continuously generate electricity for their L-ion batteries, unlimited highway mileage is possible before charging is required. Such a hybrid system incorporated with this ‘angular momentum engine’. offers one of the most energy efficient systems available today.

In summary this patent application has illustrated how to change a circular centrifugal force to a linear centrifugal force that can be used to accelerate a vehicle.

1. This engine uses the centrifugal force created by the angular momentum of a point-mass rotating around an axis to produce a constant linear centrifugal force that results in a constant linear acceleration of a vehicle.

2. The centrifugal force as claimed in claim 1, is changed from a rotating centrifugal force to a linear centrifugal force by changing the ‘relative velocity’ and ‘relative motion’ of a point-mass relative to a stationary reference point, an ‘at-rest’ observer.

3. The centrifugal force as claimed in claim 1, is a product of the point-mass times the velocity squared divided by the radius.

4. The linear centrifugal force as claimed in claim 1, is a linear pulling force, an outward force.

5. The linear centrifugal force as claimed in claim 1, uses a single stage planetary gearbox with a ‘point mass’ on each of its four planet gears, to change the relative velocity and relative motion of these ‘point-mass’, from a rotating centrifugal force to a linear centrifugal force.

6. The linear centrifugal force as claimed in claim 1, uses a single stage planetary gearbox that does not contain an ‘internal ring gear

7. The linear centrifugal force as claimed in claim 1, are generated both by the clockwise rotation of the (0.66 lb.) ‘point-mass’ by the carrier and the counter-clockwise turning of the (0.66 lb.) ‘point-mass’ by the held sun gear in planetary gearbox 1.

8. The linear centrifugal force as claimed in claim 1, are generated both by the counter clockwise rotation of the (0.66 lb.) ‘point-mass’ by the carrier and clockwise turning of the (0.66 lb.) ‘point-mass’ by the held sun gear in planetary gearbox 2.

9. The linear force as claimed in claim 1, increases as the speed of rotation increases in proportion to the square of the speed; that is, an increase in speed of 10 times say from 10 to 100 revolutions per minute, increase the centrifugal force by a factor of one hundred.

10. The linear force as claimed in claim 1, is created when the planet to sun gear ratio is 1:1 resulting in the carrier rotating the planet gears one revolution clockwise around the sun gear while simultaneously the planet gears are turned one revolution counter-clockwise by the held sun gear in ‘planetary gearbox 1’.

11. The linear force as claimed in claim 1, is created when the planet to sun gear ratio is 1:1 resulting in the carrier rotating the planet gears one revolution counter-clockwise around the sun gear while simultaneously the planet gears are turned one revolution clockwise by the held sun gear in ‘planetary gearbox 2’.

12. The linear centrifugal force as claimed in claim 1, only requires enough energy to make up for friction losses to maintain a constant centripetal force.

13. The vehicle as claimed in claim 1, can be used across the broad spectrum of transportation including space.

14. The linear centrifugal force as claimed in claim 1, as viewed by an ‘at-rest’ observer is always pointing in the same linear direction.

15. The linear centrifugal force as claimed in claim 1, provides equal centrifugal force between the four planet gears on ‘planetary gearbox 1’ and ‘planetary gearbox 2’ as they rotate in opposite directions.

16. The linear centrifugal force as claimed in claim 1, changes for each individual ‘point mass’ as they rotate around the sun gear. The net sum however remains the same’.

17. The linear centrifugal force as claimed in claim 1, is equal between the ‘side by side’ 1^{st} and 2^{nd} planetary gearboxes as they rotate in opposite directions.

18. The 2^{nd} planetary gearbox runs in the opposite direction of the 1^{st} planetary gearbox to balance the rotational and centrifugal forces of the 1^{st} planetary gearbox.

19. The linear centrifugal force as claimed in claim 1, at 4000 rpm creates 6,192 foot pounds of linear centrifugal force in this ‘angular momentum engine’ for the two gearboxes.

20. The linear centripetal force as claimed in claim 1, quadruples ‘each time’ the velocity doubles. The linear centrifugal force is therefore 256 times greater for this ‘angular momentum engine’ at 16,000 rpm (99,072 ft/lbs) than at 1000 rpm (387 ft/lbs) well beyond the normal power curve for the automotive industry.
